(19) United States
(12) Patent Application Publication
(10) Pub. No.: US 2006/0064592 A1
(43) Pub. Date: Mar. 23, 2006

(54) SYSTEM FOR CONTROLLING SMART CARD SLOTS AND METHOD FOR CONTROLLING SMART CARD SLOTS

(76) Inventors: Arkadiusz CZERWINSKI, Nowa Sol (PL); Maciej MICHALCZAK, Zielona Gora (PL)

Correspondence Address: MATTHIAS SCHOLL, 14781 MEMORIAL DRIVE, SUITE 1319, HOUSTON, TX, 77079, US

(21) Appl. No.: 10/908,138

(22) Filed: Apr. 28, 2005

(30) Foreign Application Priority Data
Sep. 20, 2004 (PL) P-370185

(51) Int. Cl. H04L 9/00; H04K 1/00

(52) U.S. Cl. 713/172; 713/185; 713/159

(57) ABSTRACT

A system for controlling smart card slots (121, 122, 123) of a device comprising smart card slots (121, 122, 123) providing access to smart card (111, 112, 113) resources via slot interfaces (103) and embedded systems (143, 145, 147, 151) requesting access to smart card resources, each embedded system (143, 145, 147, 151) provided with a client (142, 144, 146, 152), each client supporting communication via a client interface (153). The system comprises a slot manager (104) managing access to slot interfaces (103) for the embedded systems (143, 145, 147, 151) via the clients (142, 144, 146, 152) using the client interface (153), the slot manager comprising a status controller (313) for controlling the status of cards (111, 112, 113) in slots, wherein the access of the embedded systems (143, 145, 147, 151) requesting access to resources of a smart card (111, 112, 113) in a specific slot (121, 122, 123) depends on a current status of the card (111, 112, 113) in that slot (121, 122, 123) for the client (142, 144, 146, 152) of that embedded system.

### CROSS-REFERENCE TO RELATED APPLICATIONS

This application claims priority to Polish Patent Application No. P-370185, filed Sep. 20, 2004, the contents of which are incorporated herein by reference.

### BACKGROUND OF THE INVENTION

1. Field of the Invention

The object of the invention is a system for controlling smart card slots and a method for controlling smart card slots.

2. Brief Description of the Background of the Invention Including Prior Art

Smart cards, defined by ISO/IEC 7816 standard “Identification cards—Integrated circuit(s) cards with contacts”, are widely used for data transfer. Data may be read from those cards by various devices via card slots.

Smart cards are widely used with digital television decoders for signal descrambling or additional services, such as banking, telephony, or voting. These functions are controlled by specific systems embedded in the decoder, such as conditional access systems or high-level card drivers used by applications providing additional services. Such embedded systems are usually provided as modules by various companies, and the interfaces of those modules are provider-specific. Therefore, in order to handle a specific embedded system, the software of the decoder needs to be adapted to the interface of that system. This may cause problems, since such adaptation requires a considerable workload and resources.

From the European Patent No. EP 00562295 entitled “Method and apparatus for controlling several smart cards” there is known a method for controlling several smart card readers, where after a card in one reader is selected, the power supply to the other readers is switched off. Each slot is assigned to a card of a specific type. The switching-off of the power supply and a separate slot for each card type are serious drawbacks of this design.

From the U.S. Pat. No. 5,742,680 entitled “Set top box for receiving and decryption and descrambling a plurality of satellite television signals” there is known a digital television decoder with several card slots, and a card necessary to decrypt the received signal is selected. However, neither the method of selection nor the data flow have been described in detail. The drawback of such solution is that only one card can be used at a time.

From the U.S. Pat. No. 6,035,037 entitled “System for processing a video signal via series-connected high speed signal processing smart cards” there is known a system for receiving a television signal scrambled by two methods, where the signal is descrambled by two smart cards connected in series. Therefore, such a solution does not allow simultaneous descrambling of various signals by various methods.

From the PCT Publication No. WO 0180473A2 entitled “Method for standardizing the use of ISO 7816 smart cards in conditional access systems” there is known a method for using cards of various types in one device by providing a uniform application program interface (API). However, the method does not permit the simultaneous use of several cards.

### SUMMARY OF THE INVENTION

Purposes of the Invention

It is an object of the present invention to provide a simple system for controlling several types of smart cards in a device with several embedded systems requesting access to smart card resources.

This and other objects and advantages of the present invention will become apparent from the detailed description, which follows.

### BRIEF DESCRIPTION OF THE INVENTION

A system for controlling smart card slots of a device with embedded systems requesting access to smart card resources via a low-level slot interface, comprises a slot manager, which manages access to slot interfaces for embedded systems requesting access to smart card resources via system-specific program interfaces, and which provides at least functions of access to card resources, where each embedded system is provided with a client which handles communication between the embedded system and the slot manager via a client program interface, and where the slot manager comprises a status controller, controlling the status of cards in slots, and the access of embedded systems requesting access to resources of a smart card in a specific slot depends on the current status of the card in that slot for the client of that embedded system.

The client can be a block, which converts events of the system-specific program interface to events of the client program interface, and converts events of the client program interface to events of the system-specific program interface.

The slot manager can be a block which handles communication with smart card slots, which, via the slot registration block and the client registration block, collects information on available slots via and stores it in the slot-table, and collects information on the clients of the embedded systems requesting access to smart card resources and stores that information in the client-table, and determines the access of clients to slot interfaces via the access controller.

The status of the card in the slot for a specific client can be stored by the slot manager in the client-table, which contains information about clients registered for specific slots.

In the slot-table there can be stored a priority of a specific client for a specific slot, specifying the priority of access to the slot by the client in respect of other clients registered for the slot, as well as hardware configurations required by specific clients for specific slots.

The status of a card for a client can be at least “INSERTED”, where after a client's request for access to card resources the access is granted, and “NO_ACCESS”, where after a client's request for access to card resources the access is denied.

Preferably, the status controller comprises a card initialization controller handling the transition between the “INSERTED” and “NO_ACCESS” statuses, where for consecutive clients the status of the card is set to “INSERTED” and to “NO_ACCESS” for other clients, and if the client does not accept the card, the procedure is passed to the next client, and if the client accepts the card, the procedure is terminated.

The status of a card for a client can be “OVERLOAD”, where after a client's request for access to card resources information about a card error is sent, and the status of “REMOVED”, where after a client's request for access to card resources information about no card available is sent.

Preferably, the embedded systems requesting access to smart card resources are conditional access systems and/or high-level smart card drivers whereas via low-level slot interface is a digital television decoder.

Preferably, the clients are software modules provided for embedded systems requesting access to smart card resources, which handle communication with the embedded systems via a program interface uniform for all clients.

The object of the invention is also a method for controlling smart card slots of a device with embedded systems requesting access to smart card resources via a low-level slot interface, where a slot manager module is provided, which manages access to slot interfaces for embedded systems requesting access to smart card resources via system-specific program interfaces, and which provides at least the functions of access to card resources, and a client is created and provided for each embedded system, the client handling communication between the embedded system and the slot manager via a client program interface, and the slot manager is provided with a status controller, controlling the status of cards in slots, and the access of embedded systems requesting access to resources of a smart card in a specific slot is made dependent on the current status of the card in that slot for the client of that embedded system.

The communication with smart card slots can be handled via the slot manager, such that information on available slots is collected via the slot registration block and stored in the slot table, and information on the clients of the embedded systems requesting access to smart card resources is collected via the client registration block and stored in the client table, and the access of clients to slot interfaces is determined via the access controller.

### BRIEF DESCRIPTION OF THE DRAWINGS

In the accompanying drawings one of the possible embodiments of the present invention is shown, where:

FIG. 1 presents a structure of a digital television decoder with a system for controlling smart card slots;

FIG. 2A presents a method for communicating between systems requesting access to smart card resources and other blocks via clients;

FIG. 2B presents a schematic layout of client operation;

FIG. 3 presents a structure of a slot manager;

FIG. 4A presents conditions for transition between individual slot statuses;

FIG. 4B presents conditions for transition between individual card statuses;

FIG. 5 presents a flow diagram of a procedure for slot registration;

FIG. 6 presents a flow diagram of a procedure for client registration;

FIG. 7 presents a flow diagram of a procedure for card initialization; and

FIG. 8 presents a flow diagram of a procedure for access control.

### DESCRIPTION OF INVENTION AND PREFERRED EMBODIMENT

The system for controlling smart card slots according to the invention is shown in an exemplary embodiment related to a digital television decoder. Alternatively, it can be used with other devices able to handle smart cards of various types.

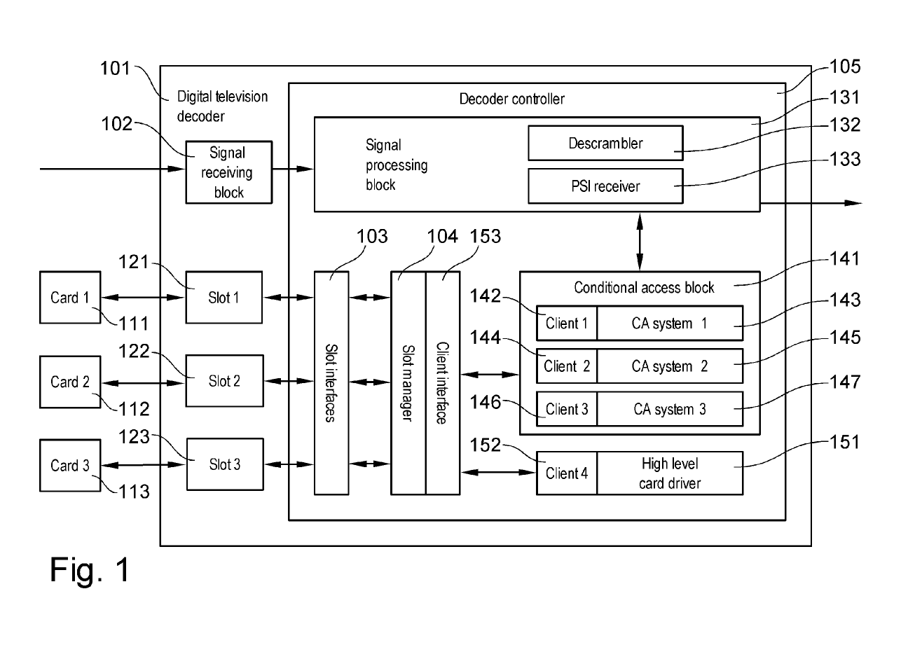

FIG. 1 presents a general structure of a digital television decoder 101 with a system for controlling smart card slots. The main element of the decoder 101 is a decoder controller 105, comprising a signal processing block and other blocks for handling various software. The decoder receives, via a signal receiving block 102 (comprising, for example, a tuner and a demodulator), a digital television signal (for example, satellite, cable or terrestrial). This can be a multi-channel block for receiving signals from several sources. The signal receiving block 102 transmits digital data streams to the signal processing block 131, which converts the signal to a format acceptable by a user terminal. For example, it decodes the MPEG format and converts the data to PAL/NTSC format. The signal received by the signal processing block 131 can be scrambled. The signal processing block comprises a descrambler 132 and a PSI (Program Specific Information) receiver 133. The descrambler 132 descrambles the received signal, and its operation is controlled by the conditional access block 141. The PSI receiver 133 monitors PSI data and transmits PSI data related to access control to the conditional access block.

The conditional access block of the decoder comprises several embedded systems requesting access to smart card resources, for example CA (Conditional Access) systems 143, 145, 147, for handling various scrambling algorithms. The conditional access systems communicate with smart cards and, based on the information read from the smart card, configure the descrambler. The decoder controller may comprise other embedded systems requesting access to smart card resources, for example a high-level smart card driver 151. The high level-smart card driver 151 handles specific transmission protocols, for example T=0 and T=1 protocols according to ISO/IEC 7816-3 norm “Identification cards—Integrated circuit(s) cards with contacts—Part 3. Electronic signals and transmission protocols”. The driver can be used by applications compliant with the OCF (Open Card Framework) standard for additional services.

One of the elements of the invention are modules for the embedded systems requesting access to smart card resources, which are in the further description referred to as “clients” 142, 144, 146, 152. The clients enable communication with the embedded systems via an application program interface uniform for all clients, referred to as the client interface.

The decoder is provided with slots 121, 122, 123 for reading smart cards 111, 112, 113. The access to resources of a card inserted to a specific slot is enabled via slot interfaces 103, which are low-level software modules. The slot interface is designed by the decoder provider and is usually different from the interfaces of the embedded systems requesting access to smart card resources.

According to the invention the slot manager 104 enables the communication of the embedded systems requesting access to smart card resources (such as conditional access systems or high-level smart card drivers) with the slot interface 103, which provides smart card resources. The communication with the embedded systems is handled via clients, providing an interface for communication with those systems, which is uniform for all clients, referred to as the client interface 153. The slot manager 104 of the present invention is a block, which controls communication with smart card slots. It can be a separate hardware element of the decoder or a software module of the decoder controller. It controls the communication between the slot interfaces embedded in the decoder controller, and systems requesting access to smart card resources, which are also embedded in the decoder controller. The systems may be, for example, high-level smart card drivers (software used by high-level applications for additional services) or conditional access systems (controlling specific devices, for example the slots or the descrambler, which can also be implemented as software). The communication between the slot interface and clients of embedded systems requesting access to smart card resources depends on the information on slots and clients, which is collected by a slot manager via a slot registration block and a client registration block. Information on slots include a slot identifier, a slot callback function (via which slot interface can be communicated) and a current status of a card for a slot. Information on clients of embedded systems requesting access to smart card resources include: a client identifier, an identifier of a slot for which the client has been registered, a priority, a client callback function (which the system can be communicated with), a status of the card for the client and a hardware configuration of the slot as required by the client. The slot manager may communicate with embedded systems requesting access to smart card resources of various providers, via clients handling the client interface. Similarly, various slots may communicate with the slot manager via the slot interfaces. In the presented embodiment, as embedded systems requesting access to smart card resources three conditional access systems have been presented and one high-level smart card driver, and three smart card slots. However, the presented system can be used for handling an arbitrary number of cards and slots.

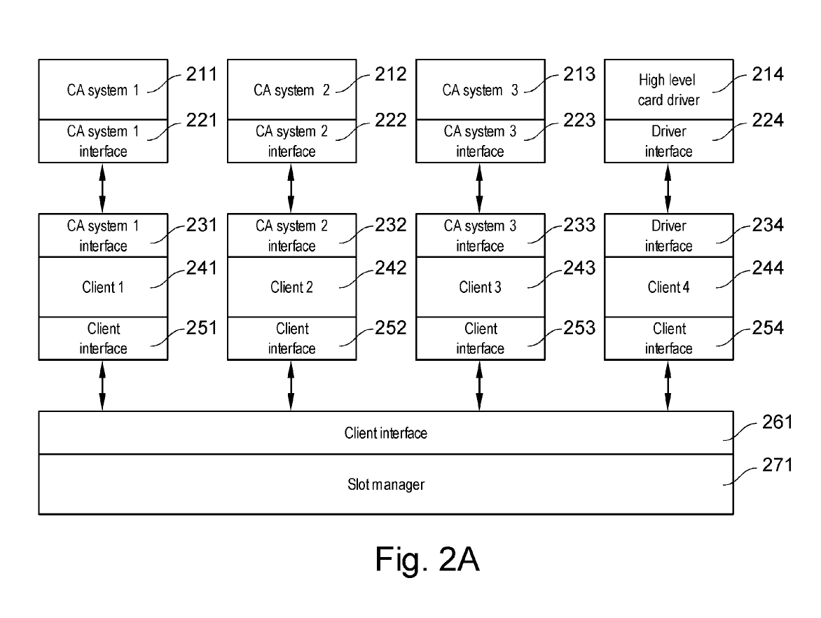

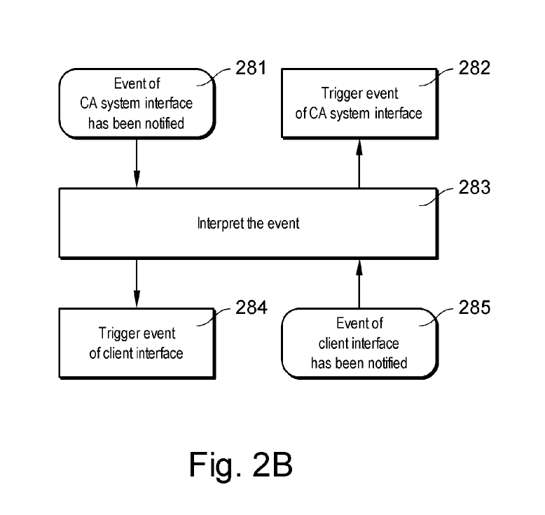

FIG. 2A presents a method for communicating between systems requesting access to smart card resources and other blocks via clients. The systems 211, 212, 213, 214 requesting access to smart card resources, communicate via individual system-specific interfaces 221, 222, 223, 224. Each system is handled by a separate client 241, 242, 243, 244. Each client communicates with its system via a system-specific interface, 231, 232, 233, 234 respectively. The main function for the client is to convert events between a system-specific interface and the client interface uniform for several clients. This allows the other blocks of the system (for example, the slot manager 271) to communicate with the systems via clients using a uniform client interface 261. Preferably, all systems requesting access to smart card resources are handled by clients allowing communication by a uniform client interface. The presented solution is advantageous for a system having at least two clients providing a uniform client interface.

FIG. 2B presents a schematic of client operation. When, at the interface of the system requiring access to smart card resources (i.e. the interface of the CA system or driver interface) handled by the client, an event is notified by the system 281, the client interprets this event 283 and next it triggers a relevant event of the client interface. Similarly, when at the client interface there appears an event 285 notified by other block (for example, by the slot manager), the client interprets this event 283 and next it triggers 282 a relevant event of the interface of the system it handles. An example of the event is a function for reading or writing specific data.

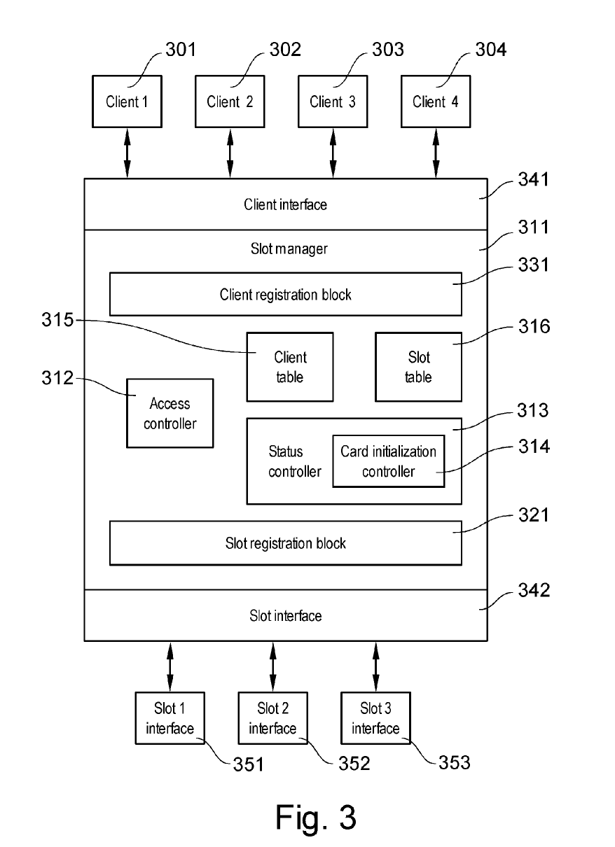

FIG. 3 presents the structure of the software layer of the system for controlling smart card slots according to the invention, comprising a slot manager 311, four cooperating clients 301, 302, 303, 304 and three slot interfaces 351, 352, 353. The slot manager 311 communicates with the clients via the client interface 341, and with the slot interfaces via the slot interface 342. In such an embodiment, clients and slot interfaces of various types may co-operate with the slot manager, and the only requirement they must meet is their support for a specific program interface.

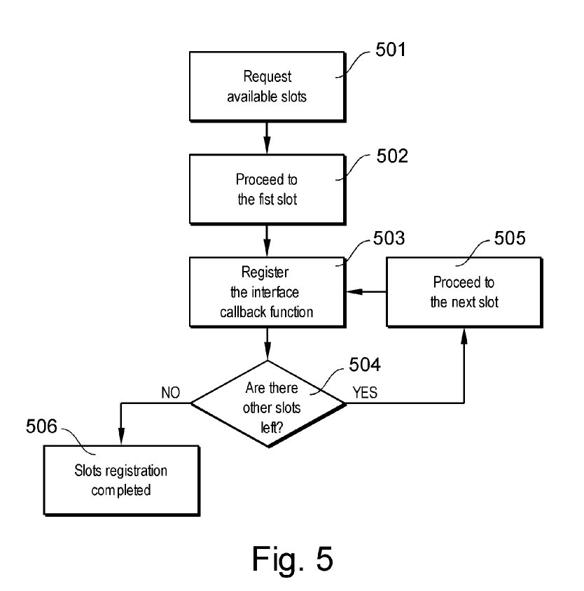

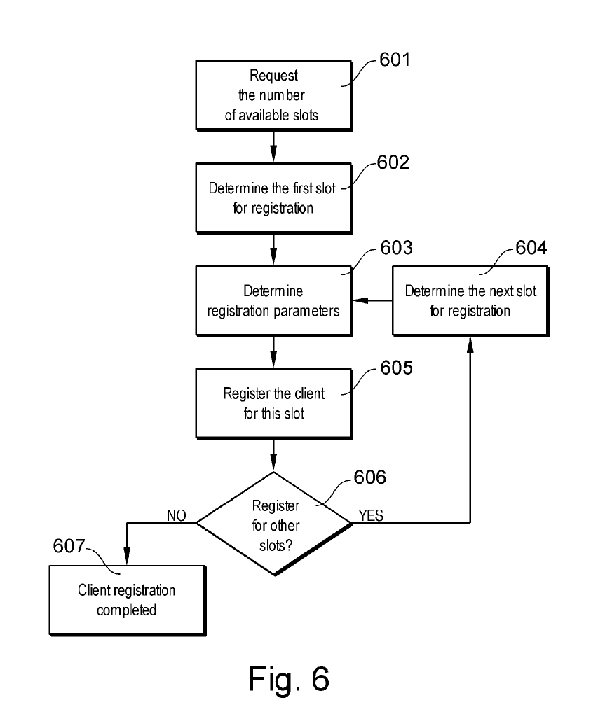

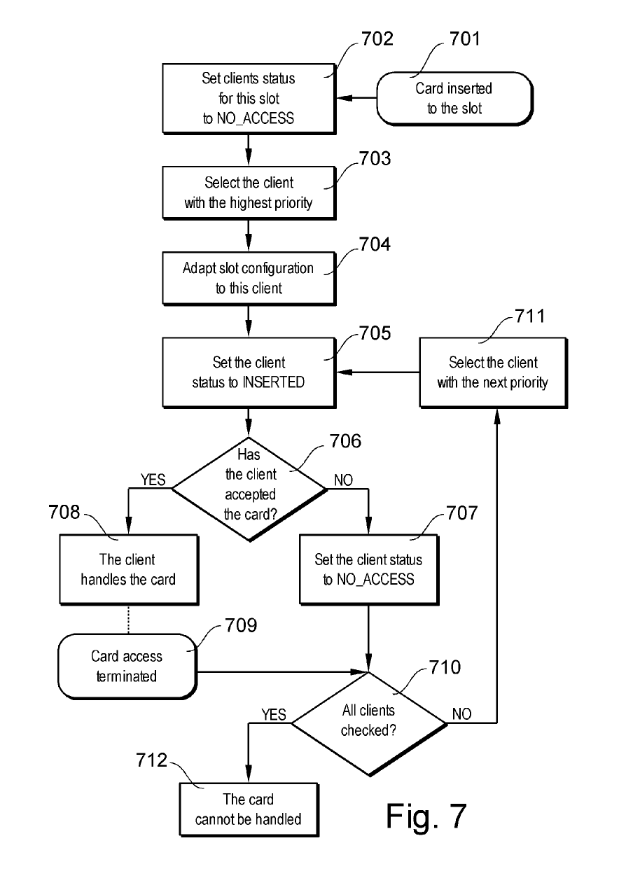

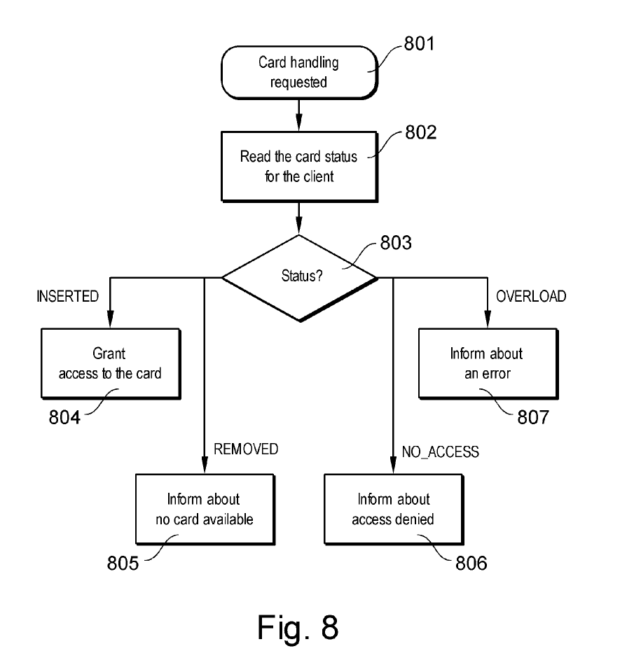

The client interface 341 enables the client to access card resources via basic functions, such as a function for reading or writing data. The access of a specific client to resources of a card depends on the current status of the card in relation to that client. The slot manager 311 additionally incorporates a slot registration block 321, responsible for initialization of slots at the start-up of the decoder, according to a procedure shown in FIG. 5. In addition, the slot manager 311 may incorporate a client registration block 331, which provides a function for registering clients (which stores registration parameters in the client table) and a function providing information about slots (which provides information on slots for clients). A typical registration process performed by the client is shown in FIG. 6. In addition, the slot manager 311 incorporates an access controller 312, which grants, or denies, access by clients to resources of specific cards. The operation of the access controller 312 is presented in FIG. 8. The statuses of cards for specific clients and slots are stored in specific data structures, which, in the presented embodiment, are tables 315 and 316, in which other data characterizing clients and slots can be stored (described below). Instead of tables, other data structures can be used. The statuses are handled by a status controller 313. Its crucial element is a card initialization controller 314, which via a procedure shown in FIG. 7 handles the transitions between NO_ACCESS and INSERTED statuses.

The statuses of cards in slots stored in the slot table can have the following values:
REMOVED, when the card has been removed from the slot or the slot is empty;
INSERTED, when the card is placed in the slot; and
OVERLOAD, when the card is placed in the slot, but an error has occurred and handling the card is not allowed. The OVERLOAD status may also appear when the card is damaged.

The statuses of cards for specific clients stored in the clients table can have the following values:
REMOVED, when the card has been removed from the slot or the slot is empty, which means that the card cannot be handled by that slot interface;
NO_ACCESS, when a card is placed in the slot, but another client uses the card, which means that the card cannot be used by the initial client;
INSERTED, when the card is placed in the slot and another client is accessing it;
OVERLOAD, when the card is placed in the slot, but an error has occurred and handling the card is not allowed.

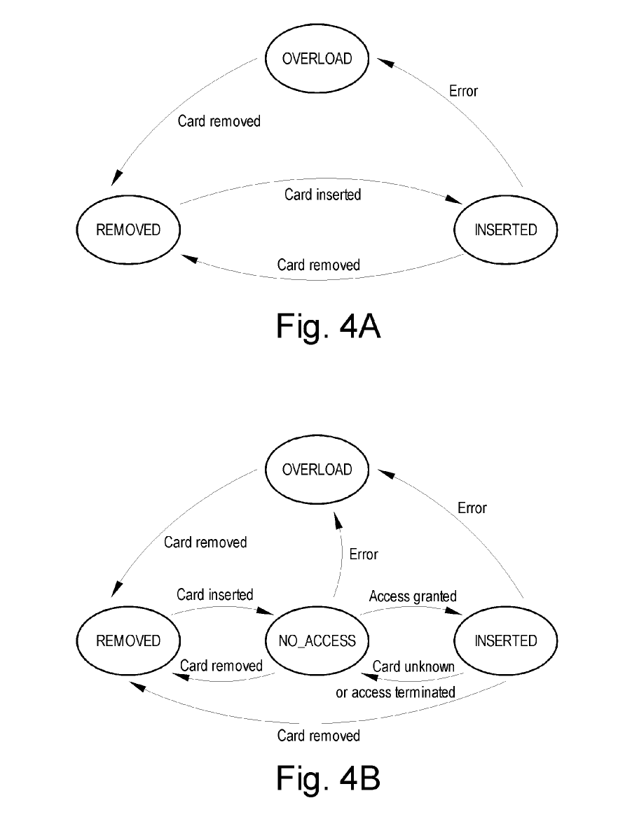

FIGS. 4A and 4B present the conditions for transition between statuses. The transitions are controlled by the status controller and the card initialization controller. The status controller receives information on events in the slot via the slot callback function, registered in the slot table. The controller informs the clients about the change of status of the card for a particular client via client callback functions, which are registered in the clients table.

FIG. 4A presents individual statuses of cards. When the slot is empty, the status of the card in that slot is specified as REMOVED. When a card is inserted, the status is changed to INSERTED, and when a card is removed, the status returns to REMOVED. When a card handling error appears, the slot changes its status to OVERLOAD, from which it can return to the REMOVED status after the card is removed from the slot.

FIG. 4B presents individual statuses of the cards for specific clients. When the slot is empty, the status of the card for each client registered for that slot is specified as REMOVED. After the card is inserted, its status for all clients is set to NO_ACCESS, apart from the client to which the access to the card is granted, and the status of that client is set as INSERTED. If that client does not recognize the card or returns the access to another client, its status returns to NO_ACCESS, and the access to the card and the status INSERTED is passed to another client, specified by priorities. The transition between NO_ACCESS and INSERTED statuses is controlled by the card initialization controller. In case a card error occurs, the status of each client for that slot is set to OVERLOAD. The return to the REMOVED status from other statuses is possible after the card has been removed from the slot.

The current statuses of the slot interfaces are stored in the slot table 316 which may have the following format:

| | | Status of |
|---|---|---|
| Slot | Handling | the card in |
| interface | function | the slot |
| 1 | Slot1_f1 | INSERTED |
| 2 | Slot2_f1 | INSERTED |
| 3 | Slot3_f1 | REMOVED |

The slot callback function is a function, which sends information to the status controller on the change of status of a card in a particular slot.

The configuration of clients for individual slots is stored in the clients table 315, which may have the following format:

| | | | | Card status | |
|---|---|---|---|---|---|
| | | | | for a | |
| | | Pri- | Handling | particular | |
| Client | Slot | ority | function | client | Configuration |
| 1 | 1 | 1 | Client1_f1 | INSERTED | Configuration_X |
| 1 | 2 | 1 | Client1_f2 | NO_ACCESS | Configuration_Y |
| 1 | 3 | 1 | Client1_f3 | REMOVED | Standard |
| 2 | 1 | 3 | Client2_f1 | NO_ACCESS | Standard |
| 3 | 1 | 2 | Client3_f1 | NO_ACCESS | Standard |
| 3 | 2 | 2 | Client3_f2 | INSERTED | Standard |
| 4 | 2 | 2 | Client4_f1 | NO_ACCESS | Configuration_Z |
| 4 | 3 | 3 | Client4_f2 | REMOVED | Standard |

The client callback function is a function, via which the status controller sends to a particular client information on the change of status of the card in a particular slot.

When a function for registering the clients is called, the client may specify a certain configuration for the slot, for example configuration related to hardware parameters: the clock frequency, supply voltage or transmission protocol. When the client does not specify certain configuration, the slot interface will handle the card in a standard way, using a default configuration.

When a function for registering the clients is called, the client may also specify a certain priority, which is used by the procedure for card initialization to determine the order of granting access. This allows quicker determination of a client for handling a specific card (the most frequent clients can be searched first) or the priority of one client compared to others (because of a subscription fee paid, user status, etc.).

FIG. 5 presents the procedure for slots registration, initialized at the decoder start-up. In the first step 501 the procedure sends a request to a low-level slot interfaces driver for the number of available slots. Next, in step 502, the procedure proceeds to the fist slot interface, for which in step 503 it registers in the slot table a callback function. In step 504 the procedure checks if there are other, hitherto unregistered slots. If there are slots to be registered, the procedure registers callback functions of those slots in step 505 of the procedure. After all slots are registered, the procedure is finished at step 506, and the slot table contains data on callback functions of all registered slots.

In another embodiment, the slots configuration may be permanently stored in the slot table, and then it is not necessary to run the registering procedure at the start-up of the decoder.

FIG. 6 presents a procedure for registration executed by all clients, who want to be registered in the clients table of the slot manager. The procedure is called up by every client at the start-up of the decoder, or at the time of registration of a new client. In the first step 601 the client sends to the slot manager a request for a number of available slots, by calling the function informing about the slots. Next, in step 602 it determines the first slot for which the client wishes to register, and in step 603 it sets the registration parameters, for example: the priority, the callback function (which can be different for each slot) and the configuration for that slot. In the next step, 605, the slot manager registers the client for the selected slot, by calling the registering function and passing the registration parameters. Next, the client decides if it would like to register for other slots, in step 606. If it wants to register for another slot, the client selects the next slot for registration in step 604. After the client is registered for all requested slots, the procedure ends in step 607, and the client parameters for requested slots are stored in the clients table.

FIG. 7 presents the procedure for card initialization, performed by the card initialization controller when a card is inserted into the slot, or when a client terminates the access to the card in step 709. After the card is inserted into the slot, in step 701, the statuses of all clients registered for the slot are set to NO_ACCESS in step 702. Next, the client with the highest priority is chosen in step 703. If the client requests in step 704 a certain configuration of the slot, the slot configuration is adjusted by passing specific parameters to the slot interface. Next, in step 705 the client is granted access to the card resources, and its status is changed to INSERTED. Next, in step 706 it is checked, if the client accepted the card and if it can handle it. If not, its status is set to NO_ACCESS in step 707 and it is checked in step 710, if all clients have been analyzed. If so, the procedure ends with a message in step 712, that the card is not handled by any of the available clients. If not, the client with the next priority is selected in step 711. If the client accepts the card, it handles the card in step 708. If, during handling the card, an event occurs which terminates the access of the client to the card (for example, termination of the client operation, termination of the subscription, error, etc.), then in step 709 an attempt is made to pass the card control to other clients.

FIG. 8 presents the procedure for access control, which controls the access of clients to cards resources. After a function for access to resources of a card in a particular slot is called in step 801, the controller reads from the clients table the status of the card for a particular client in step 802. Next, depending on the status, which is determined in step 803, it grants or denies access to card resources. If the card status for a particular client is “INSERTED”, the controller grants access to card resources in step 804. If the card status is “REMOVED”, the controller sends a message about no card in a particular slot in step 805. If the card status is “NO_ACCESS”, the controller sends a message about no access to resources of a particular card in step 806. If the card status is “OVERLOAD”, then in step 807 the controller sends a message about an error in card operation.

The access controller is an optional block, which prevents conflicts when an unauthorized client requests access to card resources. Its presence is not necessary when each client receives information on card status via a client callback function and does not attempt to access the card if its card status is other than “INSERTED”.

In the presented embodiment, the access to slot interfaces is enabled for several embedded systems requesting access to smart card resources via clients, as well as the concurrent use of several slots. The slots of this embodiment are universal, and designed for handling various cards. Their parameters, such as the transmission bit-rate, frame width, or transmission protocol, can be adapted to a specific card type. The access of clients to cards is controlled on the basis of the current status of the card for a specific client, the status being updated after a card is inserted into the slot or if access to the card is terminated by one of the clients.

The preferred embodiment having been thus described, it will now be evident to those skilled in the art that further variation thereto may be contemplated. Such variations are not regarded as a departure from the invention, the true scope of the invention being set forth in the claims appended hereto.

What is claimed is:

1. A system for controlling smart card slots of a device comprising
smart card slots (121, 122, 123) providing access to smart card (111, 112, 113) resources via slot interfaces (103);
embedded systems (143, 145, 147, 151) requesting access to smart card resources, each embedded system (143, 145, 147, 151) provided with a client (142, 144, 146, 152), each client supporting communication via a client interface (153); and
a slot manager (104) managing access to slot interfaces (103) for the embedded systems (143, 145, 147, 151) via the clients (142, 144, 146, 152) using the client interface (153), the slot manager comprising a status controller (313) for controlling the status of cards (111, 112, 113) in slots;
wherein the access of the embedded systems (143, 145, 147, 151) requesting access to resources of a smart card (111, 112, 113) in a specific slot (121, 122, 123) depends on a current status of the card (111, 112, 113) in that slot (121, 122, 123) for the client (142, 144, 146, 152) of that embedded system.

2. The system according to claim 1 wherein the client (142, 144, 146, 152) is a block which converts events of the system-specific program interface to events of the client program interface, and converts events of the client program interface to events of the system-specific program interface.

3. The system according to claim 1 wherein the slot manager (311) is a block which handles communication with smart card slots, which, via the slot registration block (321) and the client registration block (331), collects information on available slots via and stores it in the slot table (316), and collects information on the clients (301, 302, 303, 304) of the embedded systems (143, 145, 147, 151) requesting access to smart card resources and stores that information in the clients table (315), and determines the access of clients (301, 302, 303, 304) to slot interfaces via the access controller (312).

4. The system according to claim 1, wherein the status of the card in the slot for a specific client is stored by the slot manager (311) in the clients table (315), which contains information of clients registered for specific slots.

5. The system according to claim 4, wherein in the slot table (315) there is additionally stored a priority of a specific client for a specific slot, specifying the priority of access to the slot by the client in respect of other clients registered for the slot.

6. The system according to claim 4, wherein in the slot table (315) there are additionally stored hardware configurations required by specific clients for specific slots.

7. The system according to claim 1, wherein the status of a card for a client is at least “inserted”, where after client's request for access to card resources the access is granted, and “no_access”, where after client's request for access to card resources the access is denied.

8. The system according to claim 7, wherein the status controller (313) comprises a card initialization controller (314) handling the transition between the “inserted” and “no_access” statuses, where for consecutive clients the status of the card is set to “inserted” and to “no_access” for other clients, and if the client does not accept the card, the procedure proceeds to the next client, and if the client accepts the card, the procedure is terminated.

9. The system according to claim 7, wherein the status of a card for a client is additionally “overload”, where after client's request for access to card resources information about a card error is sent, and the status of “removed”, where after client's request for access to card resources information about no card available is sent.

10. The system according to claim 1, wherein the embedded systems requesting access to smart card resources are conditional access systems (143, 145, 147) and/or high-level smart card drivers (151).

11. The system according to claim 1, wherein the device is a digital television decoder (101).

12. The system according to claim 1, wherein the clients (142, 144, 146, 152) are software modules provided for embedded systems requesting access to smart card resources, which handle communication with the embedded systems via an program interface uniform for all clients.

13. A method for controlling smart card slots of a device with embedded systems requesting access to smart card resources comprising the following steps:
providing clients for embedded systems requesting access to smart card resources, the clients supporting communication via a client interface;
providing a slot manager for managing access to slot interfaces for the embedded systems via the clients using the client interface;
providing the slot manager with a status controller for controlling the status of cards in slots; and
controlling the access of the embedded systems requesting access to resources of a smart card in a specific slot on the basis of the a current status of the card in that slot for the client of that embedded system.

14. The method according to claim 13, wherein the communication with smart card slots is handled via the slot manager, such that information on available slots is collected via the slot registration block and stored in the slot table, and information on the clients of the embedded systems requesting access to smart card resources is collected via the client registration block and stored in the clients table, and the access of clients to slot interfaces is determined via the access controller.

15. The method according to claim 13, wherein the status of a card for a client is at least “inserted”, where after client's request for access to card resources the access is granted, and “no_access”, where after client's request for access to card resources the access is denied.

16. The method according to claim 15, wherein transition of card statuses between “inserted” and “no_access” status is handled via the card initialization controller being a component of the status controller, such that for consecutive clients the status of the card is set to “inserted” and to “no_access” for other clients, and if the client does not accept the card, the procedure proceeds to the next client, and if the client accepts the card, the procedure is terminated.

17. The method according to claim 16, wherein in the clients table the priority of a specific client for a specific slot is additionally stored, and the order of clients at the transition of card status for clients is determined on the basis of the priorities of clients registered for the specific slot.

18. The method according to claim 16, wherein the procedure for the transition of card status is activated after the card is inserted into the slot.

19. The method according to claim 16, wherein the procedure for the transition of card status is activated after a client accessing the card has terminated the access to the card.

20. The method according to claim 15, wherein the status of a card for a client is additionally “overload”, where after client's request for access to card resources information about a card error is sent, and the status of “removed”, where after client's request for access to card resources information about no card available is sent.

21. The method according to claim 20, wherein the status “overload” is assigned to all clients registered for a particular card when an error in handling that card occurs.

22. The method according to claim 20, wherein the status “removed” is assigned to all clients registered for a particular card after the card is removed from the slot.
